(19) United States
(12) Patent Application Publication
(10) Pub. No.: US 2026/0279398 A1
(43) Pub. Date: Sep. 17, 2026

(54) RAMP PAD SPACER FOR A HARD DISK DRIVE

(71) Applicant: Western Digital Technologies, Inc., San Jose, CA (US)

(72) Inventors: Vivek Panchal, Pleasanton, CA (US); Daniel Nguyen, San Jose, CA (US)

(21) Appl. No.: 19/076,439

(22) Filed: Mar. 11, 2025

(51) Int. Cl. G11B 21/22

(52) U.S. Cl. CPC G11B 21/22

(57) ABSTRACT

A ramp pad spacer for a hard disk drive includes a body, a pad attachment hole, and a ramp attachment hole. The body has a first surface and a second surface, opposite of the first surface, and spaced apart by a predetermined thickness of the body. The pad attachment hole and the ramp attachment hole are spaced apart from each other, and both extend through the predetermined thickness. The predetermined thickness defines a height offset between an attached component of the hard disk drive and a mounting surface of the hard disk drive in response to the ramp pad spacer being positioned between the attached component and the mounting surface.

### FIELD

This disclosure relates generally to hard disk drives, and more particularly to a ramp pad spacer for a hard disk drive.

### BACKGROUND

Data storage devices, such as hard disk drives (“HDDs”), are widely used to store digital data or electronic information for enterprise data processing systems, computer workstations, portable computing devices, digital audio players, digital video players, and the like. Generally, HDDs include read-write heads that help facilitate storage of data on magnetic disks. Each read-write head is supported on a suspension assembly. To protect the read-write heads when the HDD is inactive or during non-operational conditions, HDDs incorporate a ramp load/unload mechanism. Variations in manufacturing tolerances or design requirements often necessitate precise heights of the ramp to ensure optimal head loading and unloading performance.

### SUMMARY

A need exists for a hard disk drive and a method of assembling a hard disk drive that helps accommodate variations in ramp height. The subject matter of the present application has been developed in response to the present state of hard disk drives, and in particular, in response to problems and needs in the art, such as those discussed above, that have not yet been fully solved by currently available hard disk drives and methods of making the same. Accordingly, the examples of the present disclosure overcome at least some of the shortcomings of the prior art.

The following is a non-exhaustive list of examples, which may or may not be claimed, of the subject matter disclosed herein.

Disclosed herein is a ramp pad spacer for a hard disk drive. The ramp pad spacer includes a body having a first surface and a second surface. The first surface is opposite of the second surface and is spaced apart from the second surface by a predetermined thickness of the body. The ramp pad spacer also includes a pad attachment hole extending through the predetermined thickness of the body from the first surface to the second surface. Additionally, the ramp pad spacer includes a pad attachment hole spaced apart from the pad attachment hole by a distance and extending through the predetermined thickness of the body from the first surface to the second surface. The predetermined thickness defines a height offset between an attached component of the hard disk drive and a mounting surface of the hard disk drive in response to the ramp pad spacer being positioned between the attached component and the mounting surface. The preceding subject matter of this paragraph characterizes example 1 of the present disclosure.

The predetermined thickness of the body is uniform. The preceding subject matter of this paragraph characterizes example 2 of the present disclosure, wherein example 2 also includes the subject matter according to example 1, above.

The predetermined thickness of the body is between, and inclusive of, 0.97 mm and 1.03 mm. The preceding subject matter of this paragraph characterizes example 3 of the present disclosure, wherein example 3 also includes the subject matter according to example 2, above.

The body includes a primary docking edge at a perimeter of the body. The primary docking edge is a planar surface extending adjacent to the pad attachment hole. The body also includes an alignment-reference edge at the perimeter of the body. The preceding subject matter of this paragraph characterizes example 4 of the present disclosure, wherein example 4 also includes the subject matter according to any one of examples 1-3, above.

The pad attachment hole is smaller than the ramp attachment hole. The preceding subject matter of this paragraph characterizes example 5 of the present disclosure, wherein example 5 also includes the subject matter according to any of examples 1-4, above.

The body is a single, seamless, and monolithic structure. The preceding subject matter of this paragraph characterizes example 6 of the present disclosure, wherein example 6 also includes the subject matter according to any of examples 1-5, above.

The body is made of a metallic material. The preceding subject matter of this paragraph characterizes example 7 of the present disclosure, wherein example 7 also includes the subject matter according to any of examples 1-6, above.

Also disclosed herein is a hard disk drive including a plurality of disks, a ramp, a ramp pad, and a ramp pad spacer. The plurality of disks are configured to rotate about an axis. The ramp is positioned adjacent to the plurality of disks. The ramp pad is configured to support the ramp. The ramp pad spacer is between the ramp and the ramp pad and includes a body, a pad attachment hole, and a ramp attachment hole. The body has a first surface and a second surface. The first surface is opposite of the second surface and is spaced apart from the second surface by a predetermined thickness of the body. The pad attachment hole extends through the predetermined thickness of the body from the first surface to the second surface. The ramp attachment hole is spaced apart from the pad attachment hole by a distance, and extends through the predetermined thickness of the body from the first surface to the second surface. The ramp pad spacer is attached to the ramp pad via the pad attachment hole. The ramp is attached to the ramp pad via the ramp attachment hole. The preceding subject matter of this paragraph characterizes example 8 of the present disclosure.

The ramp pad spacer includes a primary docking edge at a perimeter of the body. The primary docking edge is a planar surface extending adjacent to the pad attachment hole. The ramp pad includes a ramp-pad primary docking surface. The primary docking edge is positioned against the ramp-pad primary docking surface to provide a contact interface between the ramp pad spacer and the ramp pad. The preceding subject matter of this paragraph characterizes example 9 of the present disclosure, wherein example 9 also includes the subject matter according to example 8, above.

The ramp includes a mounting surface that engages the ramp pad spacer and a top surface. A height of the ramp is defined between the mounting surface and the top surface. The predetermined thickness of the ramp pad spacer extends in a direction perpendicular to the height of the ramp, such that the ramp pad spacer establishes a height offset of the ramp in a z-direction relative to the ramp pad. The preceding subject matter of this paragraph characterizes example 10 of the present disclosure, wherein example 10 also includes the subject matter according to any of examples 8-9.

The ramp pad spacer is a single, seamless, monolithic structure. The preceding subject matter of this paragraph characterizes example 11 of the present disclosure, wherein example 11 also includes the subject matter according to any one of examples 8-10, above.

The ramp pad spacer is made of a metallic material. The preceding subject matter of this paragraph characterizes example 12 of the present disclosure, wherein example 12 also includes the subject matter according to any one of examples 8-11, above.

The ramp pad includes a pin. The pad attachment hole of the ramp pad spacer is configured to receive and be retained by the pin. The preceding subject matter of this paragraph characterizes example 13 of the present disclosure, wherein example 13 also includes the subject matter according to any of examples 8-12.

The hard disk drive includes a fastener. The fastener extends through the ramp attachment hole of the ramp pad spacer and a corresponding hole in the ramp. The fastener secures the ramp to the ramp pad. The preceding subject matter of this paragraph characterizes example 14 of the present disclosure, wherein example 14 also includes the subject matter according to any of examples 8-13, above.

A ratio of the predetermined thickness of the ramp pad spacer to a height of the ramp from a mounting surface of the ramp to a top surface of the ramp is between 0.07 and 0.09. The preceding subject matter of this paragraph characterizes example 15 of the present disclosure, wherein example 15 also includes the subject matter according to any of examples 8-14, above.

Also disclosed herein is a method of assembling a hard disk drive. The method includes mounting a ramp pad spacer having a predetermined thickness onto a ramp pad of the hard disk drive. The method further includes mounting a ramp onto the ramp pad spacer using a means for securing the ramp to the ramp pad through the ramp pad spacer. The ramp pad spacer is between the ramp pad and the ramp and the predetermined thickness offsets a height of the ramp relative to the ramp pad. The preceding subject matter of this paragraph characterizes example 16 of the present disclosure.

The step of mounting the ramp pad spacer having the predetermined thickness onto the ramp pad of the hard disk drive includes inserting a pin, fixed to the ramp pad, through a pad attachment hole of the ramp pad spacer. The preceding subject matter of this paragraph characterizes example 17 of the present disclosure, wherein example 17 also includes example 16, above.

The means for securing comprises a fastener. The step of mounting the ramp onto the ramp pad spacer comprises passing the fastener through the ramp, through a ramp attachment hole of the ramp pad spacer, and into the ramp pad. The preceding subject matter of this paragraph characterizes example 18 of the present disclosure, wherein example 18 also includes any of examples 16-17, above.

The method includes selecting a ramp pad spacer from a plurality of ramp pad spacers. The predetermined thickness of each one of the plurality of ramp pad spacers is different from the predetermined thickness of any other one of the plurality of ramp pad spacers. The selected one of the plurality of ramp pad spacers is selected based on a desired height offset of the ramp relative to the ramp pad. The preceding subject matter of this paragraph characterizes example 19 of the present disclosure, wherein example 19 also includes examples 16-18, above.

The step of mounting the ramp pad spacer having the predetermined thickness onto the ramp pad of the hard disk drive includes aligning a primary docking edge of the ramp pad spacer with a corresponding ramp-pad primary docking surface. The preceding subject matter of this paragraph characterizes example 20 of the present disclosure, wherein example 20 also includes any of examples 16-19, above.

The described features, structures, advantages, and/or characteristics of the subject matter of the present disclosure may be combined in any suitable manner in one or more examples and/or implementations. In the following description, numerous specific details are provided to impart a thorough understanding of examples of the subject matter of the present disclosure. One skilled in the relevant art will recognize that the subject matter of the present disclosure may be practiced without one or more of the specific features, details, components, materials, and/or methods of a particular example or implementation. In other instances, additional features and advantages may be recognized in certain examples and/or implementations that may not be present in all examples or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims or may be learned by the practice of the subject matter as set forth hereinafter.

### BRIEF DESCRIPTION OF THE DRAWINGS

In order that the advantages of the disclosure will be readily understood, a more particular description of the disclosure briefly described above will be rendered by reference to specific examples that are illustrated in the appended drawings. Understanding that these drawings depict only typical examples of the disclosure and are not therefore to be considered to be limiting of its scope, the subject matter of the present application will be described and explained with additional specificity and detail through the use of the accompanying drawings, in which:

FIG. 1 is a perspective view of a hard disk drive, according to one or more examples of the present disclosure;

FIG. 2 is a perspective partial view of a hard disk drive, according to one or more examples of the present disclosure;

FIG. 3 is a perspective view of a ramp pad spacer, according to one or more examples of the present disclosure;

FIG. 4A is a top plan view of the ramp pad spacer of FIG. 3, according to one or more examples of the present disclosure;

FIG. 4B is a cross-sectional side elevation view of the ramp pad spacer, taken along the plane 4-4 of FIG. 4A, according to one or more examples of the present disclosure;

FIG. 5A is a perspective partial view of a ramp pad, with a ramp pad spacer mounted on the ramp pad, according to one or more examples of the present disclosure;

FIG. 5B is a top partial view of the ramp pad and the ramp pad spacer of FIG. 5A, according to one or more examples of the present disclosure;

FIG. 6A is a perspective partial view of the ramp pad of FIG. 5A, with the ramp pad spacer mounted on the ramp pad and a ramp mounted to the ramp pad spacer, according to one or more examples of the present disclosure;

FIG. 6B is a top partial view of the ramp pad, the ramp pad spacer, and the ramp of FIG. 6A, according to one or more examples of the present disclosure;

FIG. 7A is a side view of a ramp mounted on a ramp pad spacer, where the ramp pad spacer has a first thickness, according to one or more examples of the present disclosure;

FIG. 7B is a side view of a ramp mounted on a ramp pad spacer, where the ramp pad spacer has a second thickness, according to one or more examples of the present disclosure; and

FIG. 8 is a schematic flow diagram of a method of assembling a hard disk drive, according to one or more examples of the present disclosure.

### DETAILED DESCRIPTION

Reference throughout this specification to “one example,” “an example,” or similar language means that a particular feature, structure, or characteristic described in connection with the example is included in at least one example of the present disclosure. Appearances of the phrases “in one example,” “in an example,” and similar language throughout this specification may, but do not necessarily, all refer to the same example. Similarly, the use of the term “implementation” means an implementation having a particular feature, structure, or characteristic described in connection with one or more examples of the present disclosure. However, absent an express correlation to indicate otherwise, an implementation may be associated with one or more examples.

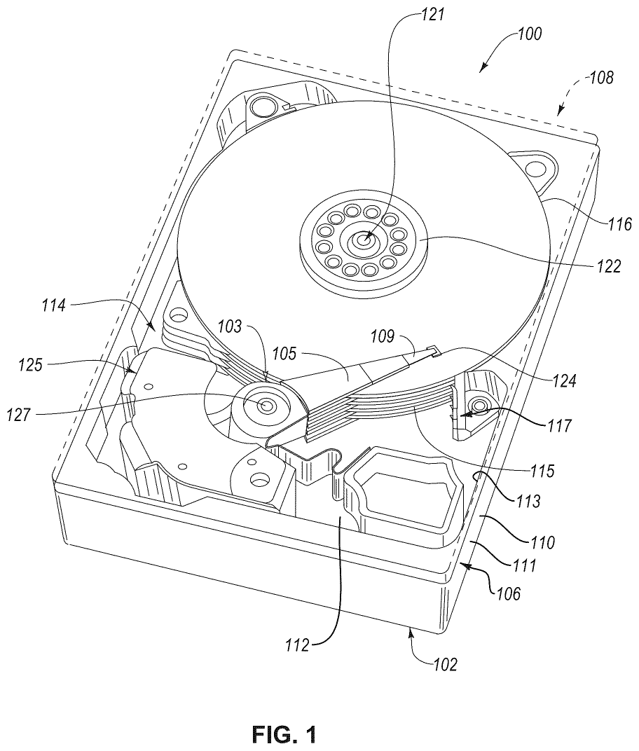

Referring to FIG. 1, a hard disk drive 100, according to one example, is shown. The hard disk drive 100 includes a housing 102 that seals or encloses an interior cavity 114 defined within the housing 102. The housing 102 includes a base 106 and a cover 108 (shown in dashed lines so as not to obscure internal features of the hard disk drive 100 within the interior cavity 114 of the housing 102). The cover 108 is coupled to the base 106 to enclose the interior cavity 114 from the environment exterior to the housing 102. In some implementations, a seal or gasket is positioned between the base 106 and the cover 108 to promote a seal between the base 106 and the cover 108. In some examples, the base 106 is made of a metallic material, such as stainless steel or aluminum.

In some examples, the base 106 includes a baseplate 112 and sidewalls 110 extending from the baseplate 112. In one or more examples, the interior cavity 114 is defined by the baseplate 112 and the sidewalls 110. In some examples, the sidewalls 110 includes an exterior surface 111 and an interior surface 113 opposite to the exterior surface 111. The interior surface 113 at least partially defines the interior cavity 114.

The hard disk drive 100 includes various features located within the interior cavity 114 of the housing 102. In some examples, the hard disk drive 100 includes a carriage 103, disks 115, a spindle motor 121, and a voice coil motor (VCM) 125 within the interior cavity 114. The carriage 103 includes a head stack assembly, which includes a plurality of carriage arms 105 and at least one head-gimbal assembly 109 (e.g., suspension), coupled to the distal tip of each carriage arm of the plurality of carriage arms 105. Each head-gimbal assembly 109 includes a suspension assembly and a slider 124. The slider 124 includes at least one read-write head coupled to (e.g., embedded in) a housing of the slider 124. Although the hard disk drive 100 in FIG. 1 is shown to have five carriage arms 105 and four disks 115, in other examples, the hard disk drive 100 can have fewer or more than five carriage arms 105 or fewer or more than four disks 115. In one example, each side of each carriage arm 105 facing a disk 115 has a head-gimbal assembly 109 (e.g., each one of bottom and top carriage arms 105 can have one head-gimbal assembly 109, and each one of middle carriage arms 105, between the bottom and top carriage arms 105, can have two head-gimbal assemblies 109). Similarly, although the hard disk drive 100 is shown to have one spindle motor 121 and one VCM 125, in other examples, the hard disk drive 100 can have any number of spindle motors 121 and VCMs 125.

The spindle motor 121 is coupled to the base 106. In some examples, the spindle motor 121 is coupled to the base 106 at the baseplate 112. Generally, the spindle motor 121 includes a stationary portion non-movably fixed relative to the base 106 and a spindle 122 that is rotatable relative to the stationary portion and the base 106.

Accordingly, the spindle 122 of the spindle motor 121 can be considered to be part of or integral with the spindle motor. Generally, the spindle motor 121 is operable to rotate the spindle 122 relative to the base 106. The disks 115, or platters, are co-rotatably fixed to the spindle 122 of the spindle motor 121 via respective hubs, which are co-rotatably secured to respective disks 115 and the spindle 122. As the spindle 122 of the spindle motor 121 rotates, the disks 115 correspondingly rotate. In this manner, the spindle 122 of the spindle motor 121 defines a rotational axis of each disk 115. The spindle motor 121 can be operatively controlled to rotate the disks 115, in a rotational direction, a controlled amount at a controlled rate.

Each one of the disks 115 may be any of various types of magnetic recording media. Generally, in one example, each disk 115 includes a substrate and a magnetic material applied directly or indirectly onto the substrate. For example, the magnetic material of the disks 115 may be conventional granular magnetic recording disks or wafers that have magnetic layer bits with multiple magnetic grains on each bit. In granular magnetic media, all of the bits are co-planar, and the read-write surface 116 of the disk is substantially smooth and continuous. In one example, each bit has a magnetic dipole moment that can either have an in-plane (longitudinal) orientation or an out-of-plane (perpendicular) orientation.

As the disks 115 rotate in a read-write mode, the VCM 125 electromagnetically engages voice coils of the carriage arms 105 to rotate the carriage arms 105, and the head-gimbal assemblies 109, which are coupled to the carriage arms 105, relative to the disks 115 in a rotational direction along a plane parallel to read-write surfaces of the disks 115. The carriage arms 105 can be rotated to position the read-write head of the head-gimbal assemblies 109 over a specified radial area of the read-write surface 116 of a corresponding disk 115 for read and/or write operations. The VCM 125 is fixed to the base 106 in engagement with the voice coils of the carriage arms 105, which are rotatably coupled to the base 106 via a spindle 127 extending through the carriage 103. Generally, the spindle 127 defines a rotational axis about which the carriage arms 105 rotate when actuated by the VCM 125.

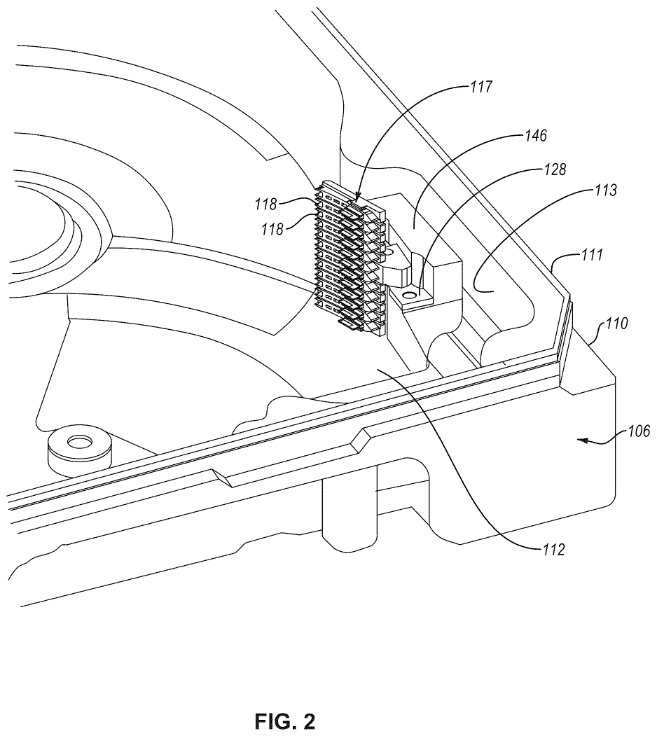

The carriage arms 105 are non-movably fixed to (e.g., integrally formed as a one-piece unitary monolithic body with) and extend away from a base of the carriage 103 in a spaced-apart manner relative to each other. In some implementations, the carriage arms 105 are spaced equi-distantly apart from each other and extend parallel relative to each other. A respective one of the disks 115 is positioned between adjacent carriage arms 105. In an idle mode (e.g., when read-write operations are not being performed), the VCM 125 is actuated to rotate the carriage arms 105, in a radially outward direction relative to the disks 115, such that the head-gimbal assemblies 109 are parked or unloaded onto a ramp 117 within the interior cavity 114. The ramp 117 provides a designated unloading and parking area for the head-gimbal assemblies 109, preventing contact with the disks 115 when the hard disk drive 100 is inactive. While FIG. 1 illustrates the general placement of the ramp 117 within the interior cavity 114 and is a simplified illustration of the ramp 117 that may not indicate its precise structure or scale. Additional details regarding the ramp shape and attachment to the base 106 of the hard disk drive 100 can be found in FIGS. 2, 6A, 6B, 7A and 7B.

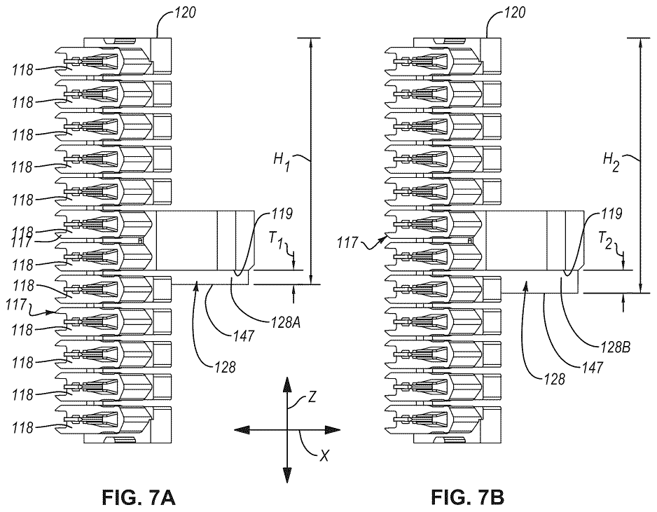

The ramp 117 is positioned adjacent to the periphery of the plurality of disks 115 and extends vertically within the interior cavity 114 of the hard disk drive 100. The ramp 117 includes multiple ramp surfaces 118 (see, e.g., FIG. 7A), each corresponding to a respective head-gimbal assembly 109, thus providing a dedicated unloading position for each read-write head. That is, the ramp 117 includes a ramp surface 118 for each head-gimbal assembly, such that the number of ramp surfaces is equal to the number of head-gimbal assemblies. Each one of the multiple ramp surfaces 118 is stacked at a different vertical height, corresponding to vertical positions of the different read-write heads. That is, the multiple ramp surfaces 118 form a tiered arrangement that aligns with the vertical stacking of the read-write heads. In some examples, the multiple ramp surfaces 118 are uniformly stacked, with an equal spacing between adjacent ones of the multiple ramp surfaces 118. The multiple ramp surfaces 118 extend outwardly and are angled or contoured to facilitate smooth engagement and disengagement of the head-gimbal assemblies 109 as they transition between an operational position over the disks 115 and an unloaded position on the ramp 117.

To better illustrate the attachment of the ramp 117, FIG. 2 illustrates a focused view of a ramp pad 146 of the housing 102 within the interior cavity 114 that serves as a mounting platform for the ramp 117. The ramp pad 146 is a structural support feature within the interior cavity 114 and is configured to provide a stable support structure that maintains the positioning and alignment of the ramp 117 relative to the disks 115 and the head-gimbal assemblies 109 (see, e.g., FIG. 1). For clarity and ease of viewing, FIG. 2 illustrates the ramp 117 and the ramp pad 146 with the disks 115 and the head-gimbal assemblies 109 removed from the hard disk drive 100. In some examples, the ramp pad 146 is integrally formed with the interior surface 113 of the sidewall 110, extending inwardly within the interior surface 113. In other examples, the ramp pad 146 is a separate component affixed to the baseplate 112 and/or the interior surface 113 of the sidewall 110, such as by fasteners, adhesive bonding, an interference fit, or other affixing method.

The positioning of the ramp 117 relative to the disks 115 is important for ensuring proper parking and unloading of the head-gimbal assemblies 109. Specifically, each ramp surface 118 must be precisely aligned in both the x-direction (e.g., radial) and Z-directions (e.g., vertical) to correspond with the respective head-gimbal assembly 109. Proper height alignment ensures that the read-write heads transition smoothly between the operational position over the disks 115 and the unloaded position on the ramp 117, thereby minimizing the risk of misalignment, mechanical interference, or damage.

Conventionally, achieving the necessary ramp placement for a specific hard disk drive necessitated choosing and using one of multiple ramp variants, each with a different overall height—such as nominal, low (e.g., nominal −20 μm), and high (e.g., nominal +20 μm)—to meet specific alignment requirements. However, this selective ramp process increases manufacturing complexity and production costs by requiring the design and production of multiple ramp sizes. To address this shortcoming of conventional hard disk drives, the present design incorporates a ramp pad spacer 128, positionable between the ramp 117 and the ramp pad 146, to precisely adjust a height offset of the ramp 117 relative to the ramp pad 146. By selecting one of multiple ramp pad spacers 128, each with a different predetermined thickness, a single nominal ramp variant can be used across different hard disk drive configurations, thus eliminating the need for multiple ramp variants. While utilizing multiple ramp pad spacers 128 of different sizes, instead of multiple ramps 117 of different sizes does not necessarily decrease the number of components associated with the manufacturing of hard disk drives, because the ramp pad spacers 128 are smaller, simpler, and less expensive to manufacture than multiple ramp variants, the presently disclosed hard disk drive configurations reduce overall production costs while maintaining required alignment for reliable operation.

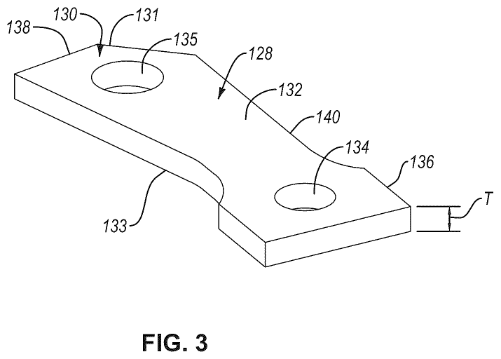

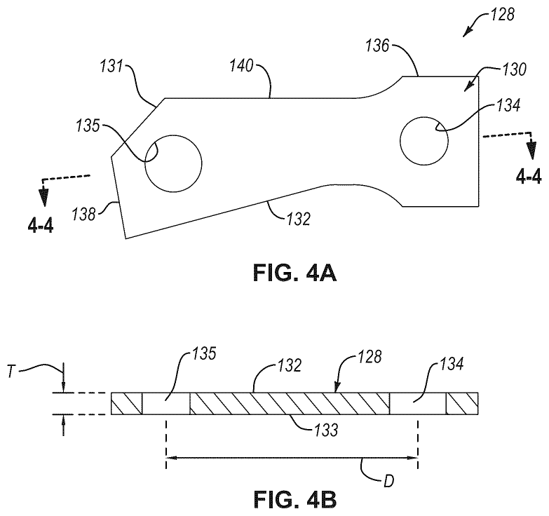

As shown in FIGS. 3, 4A, and 4B, one example of a ramp pad spacer 128 includes a body 130 having a first surface 132 and a second surface 133. The first surface 132 is opposite the second surface 133, and the two surfaces are spaced apart by a predetermined thickness (T) of the ramp pad spacer 128. The predetermined thickness (T) defines a height offset between an attached component and a mounting surface of a hard disk drive 100 in response to the ramp pad spacer 128 being positioned between the attached component and the mounting surface. In some examples, the attached component is the ramp 117 and the mounting surface is the mounting surface 147 of the ramp pad 146. Specifically, the ramp pad spacer 128 is configured to adjust a height of the ramp 117 in a z-direction relative to the mounting surface 147 of the ramp pad 146, to ensure proper alignment for parking and unloading of the head-gimbal assemblies. In other words, the ramp 117 is higher, by a distance equal to the predetermined thickness (T), relative to the ramp pad 146 in response to the ramp pad spacer 128 being attached to the ramp 117 and positioned between the ramp pad 146 and the ramp 117 than when the ramp 117 is attached directly to the ramp pad 146. Accordingly, instead of attaching the ramp 117 directly to the ramp pad 146, the ramp pad spacer 128 is configured to be attached to the ramp 117 of the hard disk drive 100 and configured to be positioned between the ramp pad 146 and the ramp 117. In other examples, the ramp pad spacer 128 may be used between other components of the hard disk drive 100 to provide a controlled height adjustment for various structural and operational requirements. For clarity, the following description primarily refers to the ramp pad spacer 128 as being positioned between the ramp 117 and the ramp pad 146, though other configurations of the ramp pad spacer 128 within the hard disk drive 100 are possible.

In some examples, the predetermined thickness (T) is uniform across the entirety of the body 130. That is, the first surface 132 and the second surface 133 remain parallel across a width and a length (e.g., area) of the body 130. In other examples, the predetermined thickness (T) may vary across the body 130 to accommodate specific variations in the ramp 117 and the ramp pad 146. Regardless of whether the thickness (T) is uniform or non-uniform, the ramp pad spacer 128 is configured to provide a consistent height offset of the ramp 117 relative to the ramp pad 146.

The thickness (T) of the ramp pad spacer 128 can be manufactured to tight tolerances to ensure precise height adjustment of the ramp 117. Tight tolerances of the ramp pad spacer 128 can help to maintain accurate and consistent alignment of the ramp 117 and the disks 115 and the head-gimbal assemblies 109, which is important for proper operation of the hard disk drive 100. In some examples, the thickness (T) of the body is between, and inclusive of, 0.95 mm and 1.05 mm. In other examples, the thickness (T) of the body is between, and inclusive of, 0.97 mm and 1.03 mm.

In some examples, the predetermined thickness (T) of the ramp pad spacer 128 is defined relative to a partial height of the ramp 117 from a ramp mounting surface 119 of the ramp 117 to a top surface 120 of the ramp 117 (see, i.e., FIGS. 7A and 7B). In some examples, the partial height of the ramp 117 (as measured from surfaces 119 to 120) is approximately 12.556 mm. In some examples, a ratio of the predetermined thickness (T) of the ramp pad spacer 128 to the partial height of the ramp 117 (as measured from surfaces 119 to 120) is between, and inclusive of, 0.07 and 0.09. In other examples, the ratio is between, and inclusive of, 0.0773 and 0.082.

Referring back to FIGS. 3, 4A, and 4B, the body 130 includes at least two apertures: a pad attachment hole 134 and a ramp attachment hole 135. The pad attachment hole 134 extends through the predetermined thickness (T) from the first surface 132 to the second surface 133. The pad attachment hole 134 is shaped and sized to receive and retain a pin or other attachment feature of the ramp pad 146 for mounting the ramp pad spacer 128 to the ramp pad 146. In some examples, the pad attachment hole 134 may include additional structural features, such as keying slots, countersinks, chamfers, or internal threading to enhance attachment stability to the ramp pad 146.

The ramp attachment hole 135 also extends through the predetermined thickness (T) from the first surface 132 to the second surface 133. The ramp attachment hole 135 is shaped and sized to receive a fastener or other securing element that couples the ramp 117 to the ramp pad spacer 128. In some examples, the ramp attachment hole 135 may have an elongated or non-circular shape to allow for slight positional adjustment when mounting the ramp 117. Additionally, or alternatively, in some examples, the ramp attachment hole 135 may include structural features, such as keying slots, countersinks, chamfers, or internal threading, to facilitate secure attachment and alignment. The pad attachment hole 134 is spaced apart from the ramp attachment hole 135 by a distance (D), defined as the shortest distance between central axes of the holes, as shown in FIG. 4B. The sectional view in FIG. 4B is taken along plane 4-4 of FIG. 4A, which bisects the pad attachment hole 134 and the ramp attachment hole 135 to illustrate the internal structure of the ramp pad spacer 128. In some examples, additional apertures may be included, or alternative spacing arrangements may be implemented, to accommodate different hard disk drive configurations.

In some examples, the pad attachment hole 134 is smaller in diameter than the ramp attachment hole 135. The size difference may correspond to variations in attachment mechanisms, such as pins for the pad attachment hole 134 and threaded fasteners for the ramp attachment hole 135. In some examples, the pad attachment hole 134 has a diameter ranging between, and inclusive of, 1.5 mm and 3.0 mm, while the ramp attachment hole 135 has a diameter ranging between, and inclusive of, 2.0 mm and 3.5 mm.

The body 130 of the ramp pad spacer 128 has a perimeter 131. The perimeter 131 may have a complex shape that includes both curved surfaces and planar surfaces. Specifically, the shape of the perimeter 131 may be designed to accommodate mounting features and alignment surfaces necessary for integration within the hard disk drive 100. In some examples, the perimeter 131 includes a primary docking edge 136, an alignment-reference edge 138, and a transition edge 140, that may contribute to the alignment and securement of the ramp pad spacer 128 with the ramp pad 146. The primary docking edge 136 is a planar surface extending adjacent to the pad attachment hole 134 and is configured to interface with a corresponding surface on the ramp pad 146. The alignment-reference edge 138 is a planar surface extending adjacent to the ramp attachment hole 135 at an oblique angle relative to the primary docking edge 136. While it may not directly engage with the ramp pad 146, it is configured to serve as a geometric reference to maintain proper spacing and orientation of the ramp pad spacer 128. That is, in some examples, when the ramp pad spacer 128 is attached to the ramp pad 146 the alignment-reference edge 138 may be spaced apart from the ramp pad 146, in other examples, the alignment-reference edge 138 may be in contact with the ramp pad 146.

The transition edge 140 forms a curved or contoured surface that bridges the primary docking edge 136 and the alignment-reference edge 138. In some examples, the transition edge 140 may be shaped with specific curvature or edges to facilitate placement of the ramp pad spacer 128 within the hard disk drive 100 while minimizing interference with surrounding components.

The ramp pad spacer 128 has a single, seamless, and monolithic structure in some examples. The monolithic design may simplify manufacturing, reduce assembly complexity, and minimize the risk of dimensional inconsistencies that could affect alignment within the hard disk drive 100. In some examples, the ramp pad spacer 128 is made of a metallic material, such as aluminum, stainless steel, or a metal alloy. Alternatively, in other examples, the ramp pad spacer 128 is made of a non-metallic material, such as a high-performance polymer or composite material.

A plurality of ramp pad spacers 128, each differently configured relative to any other one of the ramp pad spacers 128, may be provided, which enables for the selection of a ramp pad spacer with a predetermined thickness (T) that best suits the specific alignment requirements of a given hard disk drive. That is, a selected one of the plurality of ramp pad spacers 128 with the necessary predetermined thickness (T) may be provided and mounted within a given hard disk drive to position the ramp 117 at an optimal height relative to the ramp pad 146 in order to maintain proper alignment with the disks 115 and head-gimbal assemblies 109. In some examples, the predetermined thickness (T) of each one the plurality of ramp pad spacers 128 is different from the predetermined thickness (T) of any other one of the plurality of ramp pad spacers 128. The selected one of the plurality of ramp pad spacers 128 is selected based on a desired height offset of the ramp 117 relative to the ramp pad 146. In some examples, the plurality of ramp pad spacers 128 may include five variations, each having a different thickness, such as, but not limited to, 0.95 mm, 0.97 mm, 1.0 mm, 1.03 mm, and 1.05 mm. The availability of multiple thicknesses of ramp pad spacers 128 enables for fine-tuned adjustments of the height offset of the ramp 117, thus reducing the need for manufacturing multiple ramp variants.

The use of the ramp pad spacer 128, having a precise thickness, not only enables controlled height adjustment but also enhances long-term operational reliability of the hard disk drive 100. By ensuring repeatable and stable positioning of the ramp 117, the ramp pad spacer 128 reduces risks associated with mechanical misalignment, excessive stress on the head-gimbal assemblies 109, and potential head crashes. As a result, the ramp pad spacer 128 provides a robust and adaptable solution for ensuring reliable long-term functionality of the hard disk drive.

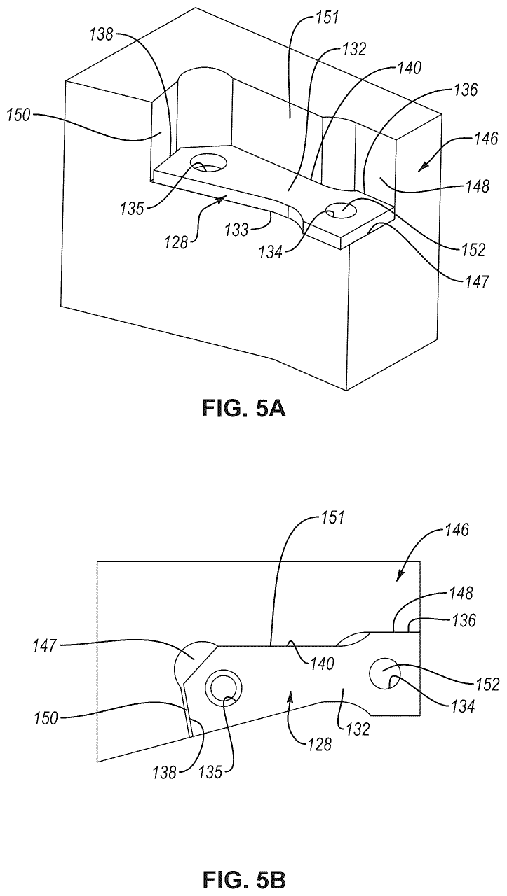

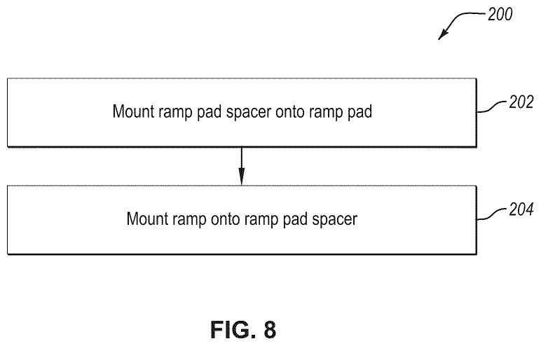

Referring to FIG. 8, one example of a method 200 of assembling a hard disk drive 100 is shown. The method 200 includes (block 202) mounting a ramp pad spacer 128 having a predetermined thickness (T) onto a ramp pad 146 of the hard disk drive 100. Accordingly, as shown in FIGS. 5A and 5B, the ramp pad spacer 128 is mounted onto the ramp pad 146. Specifically, the second surface 133 of the ramp pad spacer 128 is positioned against a mounting surface 147 of the ramp pad 146. The mounting surface 147 provides a support platform for the ramp pad spacer 128 and defines a reference plane for positioning the ramp 117. Specifically, the mounting surface 147 establishes a fixed baseline for measuring the height offset of the ramp 117 relative to the ramp pad 146. Accordingly, the mounting surface 147 is configured to support and align the ramp 117 in a predetermined position relative to the disks 115 and the head-gimbal assemblies 109. The mounting surface 147 is generally planar and perpendicular to the thickness (T) of the ramp pad spacer 128, such that in response to the ramp pad spacer 128 being mounted on the mounting surface 147, the ramp pad spacer 128 establishes the height offset in the z-direction between the ramp 117 and the ramp pad 146. In some examples, the mounting surface 147 is integrally formed as part of the ramp pad 146, creating a continuous and rigid base for the ramp pad spacer 128. In other examples, the mounting surface 147 may include machined, casted, or molded features such as raised edges or recessed pockets, to enhance engagement and positioning of the ramp pad spacer 128.

In some examples, the mounting process includes inserting a pin 152, fixed to the ramp pad 146, through the pad attachment hole 134 of the ramp pad spacer 128. The pin 152 serves as an alignment and retention feature, ensuring that the ramp pad spacer 128 is correctly positioned and retained relative to the ramp pad 146 before securing the ramp 117 to the ramp pad spacer 128. The pin 152 may be integrally formed or attached to the ramp pad 146 using various fastening techniques. In some examples, the pin 152 is a press-fit pin, which is secured into a corresponding bore within the ramp pad 146 using an interference fit. In other examples, the pin 152 may be integrally formed with the ramp pad 146, such as by machining, molding, or casting as part of the ramp pad 146. Alternatively, the pin 152 may be secured using threaded engagement, welding, adhesive bonding, or other attachment methods.

The pad attachment hole 134 of the ramp pad spacer 128 is sized to receive the pin 152 with an appropriate clearance fit or interference fit, depending on the desired level of securement. That is, in some examples, the pad attachment hole 134 has a slightly larger diameter than the pin 152, to enable the ramp pad spacer 128 to be easily positioned while still maintaining alignment. While the pin 152 is one example of an alignment feature, other attachment mechanisms may also be used. In some examples, the ramp pad spacer 128 may include a keyed slot or notch instead of a hole, allowing it to engage with a corresponding protrusion on the ramp pad 146.

When mounting, the primary docking edge 136 of the ramp pad spacer 138 has a contact interface with a corresponding ramp-pad primary docking surface 148 of the ramp pad 146. That is, the planar surface of the primary docking edge 136 is positioned against the ramp-pad primary docking surface 148 to provide consistent lateral positioning of the ramp pad spacer 128. The ramp-pad primary docking surface 148 serves as a fixed reference surface that helps to restrict lateral movement of the ramp pad spacer 128 such that it remains properly aligned before and after final fastening of the ramp 117.

Additionally, in some examples, the alignment-reference edge 138 of the ramp pad spacer 128 is positioned adjacent to but does not make direct contact with a ramp-pad alignment surface 150 of the ramp pad 146. Unlike the primary docking edge 136, which engages with the ramp-pad primary docking surface 148, the alignment-reference edge 138 does not provide a direct contact interface but instead serves as a reference feature for positioning. The alignment-reference edge 138 extends at an oblique angle relative to the primary docking edge 136, contributing to the overall fitment of the ramp pad spacer 128 within the hard disk drive 100. The transition edge 140, located between the primary docking edge 136 and the alignment-reference edge 138, may also aid in guiding the ramp pad spacer 128 into position when mounting. In some examples, the transition edge 140 at least partially interfaces with a transition surface 151 of the ramp pad 146. The transition surface 151 may include one or more rounded, chamfered, or contoured surfaces to further facilitate mounting of the ramp pad spacer 128.

Referring back to FIG. 8, the method 200 also includes (block 204) mounting a ramp 117 onto the ramp pad spacer 128, such that the ramp pad spacer 128 is positioned between the ramp pad 146 and the ramp 117. The predetermined thickness (T) of the ramp pad spacer 128 establishes the height offset of the ramp 117 relative to the ramp pad 146, which helps to ensure proper alignment for interaction between the ramp 117 and the head-gimbal assemblies 109. In some implementations, if a height offset is not required, the ramp 117 may be directly attached to the ramp pad 146 without the use of a ramp pad spacer 128, such that a ramp mounting surface 119 of the ramp 117 directly interfaces with the mounting surface 147 of the ramp pad 146. The predetermined thickness (T) of the ramp pad spacer 128 extends in a direction perpendicular to a height of the ramp 117, such as the height is defined between a ramp mounting surface 119 of the ramp 117 and a top surface 120 of the ramp 117 (see, i.e., FIGS. 7A and 7B). Accordingly, the predetermined thickness (T) of the ramp pad spacer 128 established a height offset of the ramp 117 in a z-direction relative to the ramp pad 146. This ensures proper alignment for interaction between the ramp 117 and the head-gimbal assemblies 109.

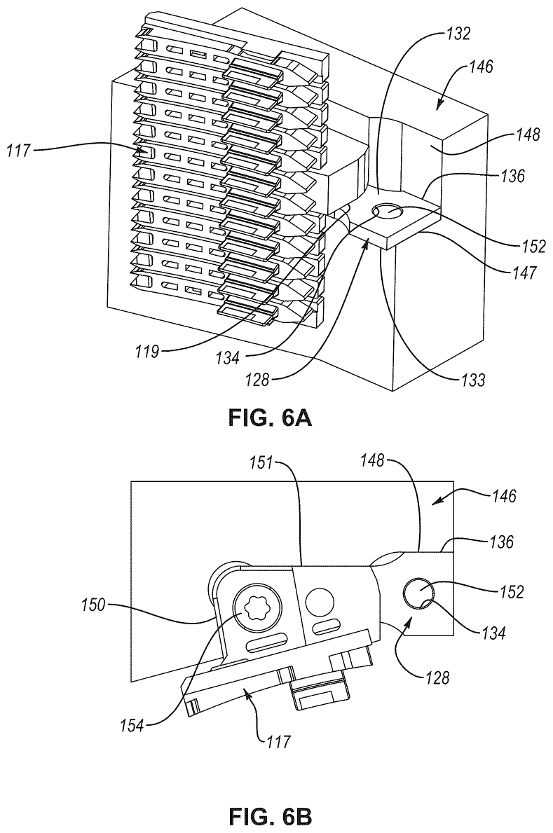

As shown in FIGS. 6A and 6B, the ramp 117 is positioned onto the ramp pad spacer 128. That is, the mounting features of the ramp 117 are aligned with the ramp attachment hole 135 of the ramp pad spacer 128 and other structural elements of the ramp pad 146. The primary docking edge 136 remain engaged with the ramp-pad primary docking surface 148 of the ramp pad 146 before and after mounting of the ramp 117.

The ramp 117 is secured onto the ramp pad spacer 128 by passing a fastener 154 through a corresponding hole in the ramp 117, through the ramp attachment hole 135 of the ramp pad spacer 128, and into a corresponding attachment feature of the ramp pad 146. The fastener 154 may include but is not limited to, a screw, bolt, press-fit pin, rivet, or another securing element configured to provide mechanical retention. In some examples, the fastener 154 may be a threaded fastener that engages with a threaded bore in the ramp pad 146, which allows for secure fastening and can enable removal, if necessary. In other examples, a press-fit pin may be used, relying on an interference fit between the fastener 154 and the receiving hole in the ramp pad 146 to maintain securement. Alternatively, adhesive bonding may be used in place of, or in addition to, a traditional fastener. Once secured, the ramp 117 is properly positioned relative to the disks 115 of the hard disk drive 100, which ensures that the head-gimbal assemblies 109 can park and unload properly. The secure attachment of the ramp 117 to the ramp pad spacer 128 and the ramp pad 146 help prevent micro-movements or misalignment of the ramp 117 that could otherwise lead to operational inconsistencies, wear, or mechanical failure over time.

In some examples, the method 200 may include selecting a ramp pad spacer 128 from a plurality of ramp pad spacers, where each one of the plurality of ramp pad spacers has a different predetermined thickness (T), as described above. That is, a plurality of ramp pad spacers 128 may be provided to enable selection of an appropriate ramp pad spacer 128 for achieving a desired height offset of the ramp 117. By choosing a ramp pad spacer 128 with a suitable thickness, the height of the ramp 117 relative to the ramp pad 146 can be fine-tuned to meet alignment requirements of the hard disk drive 100. As shown in FIGS. 7A and 7B, ramp pad spacers 128 having different thicknesses are utilized to adjust the height of the same ramp 117, to be mounted at different height positions based on the selection of the ramp pad spacer 128 with an appropriate thickness. That is, the selected ramp pad spacer 128 determines the overall z-direction height (e.g., vertical positioning) of the ramp 117 relative to the ramp pad 146 (not shown) within the hard disk drive 100.

In one embodiment, as shown in FIG. 7A, the ramp 117 is mounted onto a first ramp pad spacer 128A, having a first thickness (T₁). Accordingly, a first height (H₁) is defined as a z-direction distance from the mounting surface 147 of the ramp pad to a top surface 120 of the ramp 117. In other words, the first height (H₁) includes the sum of the first thickness (T₁) of the first ramp pad spacer 128A, as well as the partial height of the ramp 117 measured from a ramp mounting surface 119 of the ramp 117 (i.e., the surface of the ramp that interfaces with the ramp pad spacer) to the top surface 120 of the ramp 117. The ramp 117 is depicted with nine ramp surfaces 118; however, the ramp 117 may include more or less than the nine ramp surfaces, depending on the number of corresponding head-gimbal assemblies. The selected ramp pad spacer 128, such as ramp pad spacer 128A, adjusts the position of the multiple ramp surfaces 118 relative to the mounting surface 147 of the ramp pad 146, which ensures that each ramp surface 118 is precisely aligned at the appropriate height to correspond with the respective head-gimbal assemblies.

In another embodiment, as shown in FIG. 7B, the ramp 117 is mounted onto a second ramp pad spacer 128B, having a second thickness (T₂), which is greater than the first thickness (T₁). Accordingly, a second height (H₂) is defined as a vertical distance from the mounting surface 147 of the ramp pad to the top surface 120 of the ramp 117. Similar to the first embodiment, the second height (H₂) is determined by the sum of the second thickness (T₂) of the second ramp pad spacer 128B and the partial height of the ramp 117 from the ramp mounting surface 119 to the top surface 120 of the ramp 117.

As the first thickness (T₁) of the first ramp pad spacer 128A is less than the second thickness (T₂) of the second ramp pad spacer 128B, the first height (H₁) in FIG. 7A is less than the second height (H₂) in FIG. 7B. That is, as the thickness of the ramp pad spacer 128 increases, the overall z-direction positioning of the ramp 117 is raised accordingly. By selecting a ramp pad spacer 128 with an appropriate thickness, the height offset of the ramp 117 can be precisely adjusted to achieve the desired alignment of the ramp 117 for proper operation within the hard disk drive 100.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.”

The term “about” or “substantially” or “approximately”, in some embodiments, is defined to mean within +/−5% of a given value, however in additional embodiments any disclosure of “about” or “substantially” or “approximately” may be further narrowed and claimed to mean within +/−4% of a given value, within +/−3% of a given value, within +/−2% of a given value, within +/−1% of a given value, or the exact given value. Further, when at least two values of a variable are disclosed, such disclosure is specifically intended to include the range between the two values regardless of whether they are disclosed with respect to separate embodiments or examples, and specifically intended to include the range of at least the smaller of the two values and/or no more than the larger of the two values. Additionally, when at least three values of a variable are disclosed, such disclosure is specifically intended to include the range between any two of the values regardless of whether they are disclosed with respect to separate embodiments or examples, and specifically intended to include the range of at least the A value and/or no more than the B value, where A may be any of the disclosed values other than the largest disclosed value, and B may be any of the disclosed values other than the smallest disclosed value.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

The present subject matter may be embodied in other specific forms without departing from its spirit or essential characteristics. The described examples are to be considered in all respects only as illustrative and not restrictive. All changes which come within the meaning and range of equivalency of the claims are to be embraced within their scope.

1. A ramp pad spacer for a hard disk drive, the ramp pad spacer comprising:
a body having a first surface and a second surface, wherein the first surface is opposite the second surface and is spaced apart from the second surface by a predetermined thickness of the body;
a pad attachment hole extending through the predetermined thickness of the body from the first surface to the second surface; and
a ramp attachment hole spaced apart from the pad attachment hole by a distance, and extending through the predetermined thickness of the body from the first surface to the second surface;
wherein the predetermined thickness defines a height offset between an attached component of the hard disk drive and a mounting surface of the hard disk drive in response to the ramp pad spacer being positioned between the attached component and the mounting surface.

2. The ramp pad spacer of claim 1, wherein the predetermined thickness of the body is uniform.

3. The ramp pad spacer of claim 2, wherein the predetermined thickness of the body is between, and inclusive of, 0.97 millimeters (mm) and 1.03 mm.

4. The ramp pad spacer of claim 1, wherein:
the body further comprises a primary docking edge at a perimeter of the body, wherein the primary docking edge is a planar surface extending adjacent to the pad attachment hole.

5. The ramp pad spacer of claim 1, wherein the pad attachment hole is smaller than the ramp attachment hole.

6. The ramp pad spacer of claim 1, wherein the body is a single, seamless, and monolithic structure.

7. The ramp pad spacer of claim 1, wherein the body is made of a metallic material.

8. A hard disk drive, comprising:
a plurality of disks configured to rotate about an axis;
a ramp positioned adjacent to the plurality of disks;
a ramp pad configured to support the ramp; and
a ramp pad spacer between the ramp and the ramp pad, the ramp pad spacer comprising:
a body having a first surface and a second surface, wherein the first surface is opposite of the second surface and is spaced apart from the second surface by a predetermined thickness of the body;
a pad attachment hole extending through the predetermined thickness of the body from the first surface to the second surface; and
a ramp attachment hole spaced apart from the pad attachment hole by a distance, the ramp attachment hole extending through the predetermined thickness of the body from the first surface to the second surface;
wherein:
the ramp pad spacer is attached to the ramp pad via the pad attachment hole; and
the ramp is attached to the ramp pad via the ramp attachment hole.

9. The hard disk drive of claim 8, wherein:
the ramp pad spacer comprises a primary docking edge at a perimeter of the body, wherein the primary docking edge is a planar surface extending adjacent to the pad attachment hole;
the ramp pad comprises a ramp-pad primary docking surface; and
the primary docking edge is positioned against the ramp-pad primary docking surface to provide a contact interface between the ramp pad spacer and the ramp pad.

10. The hard disk drive of claim 8, wherein:
the ramp comprises a ramp mounting surface that engages the ramp pad spacer and a top surface, wherein a height of the ramp is defined between the ramp mounting surface and the top surface; and
the predetermined thickness of the ramp pad spacer extends in a direction perpendicular to the height of the ramp, such that the ramp pad spacer establishes a height offset of the ramp in a z-direction relative to the ramp pad.

11. The hard disk drive of claim 8, wherein the ramp pad spacer is a single, seamless, monolithic structure.

12. The hard disk drive of claim 8, wherein the ramp pad spacer is made of a metallic material.

13. The hard disk drive of claim 8, wherein:
the ramp pad comprises a pin; and
the pad attachment hole of the ramp pad spacer is configured to receive and be retained by the pin.

14. The hard disk drive of claim 8, further comprising a fastener, wherein:
the fastener extends through the ramp attachment hole of the ramp pad spacer and a corresponding hole in the ramp; and
the fastener secures the ramp to the ramp pad.

15. The hard disk drive of claim 8, wherein a ratio of the predetermined thickness of the ramp pad spacer to a height of the ramp from a ramp mounting surface of the ramp to a top surface of the ramp is between 0.07 and 0.09.

16. A method of assembling a hard disk drive, the method comprising:
mounting a ramp pad spacer having a predetermined thickness onto a ramp pad of the hard disk drive; and
mounting a ramp onto the ramp pad spacer using a means for securing the ramp to the ramp pad through the ramp pad spacer, wherein the ramp pad spacer is between the ramp pad and the ramp, and wherein the predetermined thickness offsets a height of the ramp relative to the ramp pad.

17. The method of claim 16, wherein the step of mounting the ramp pad spacer having the predetermined thickness onto the ramp pad of the hard disk drive comprises inserting a pin, fixed to the ramp pad, through a pad attachment hole of the ramp pad spacer.

18. The method of claim 16, wherein the means for securing comprises a fastener, and the step of mounting the ramp onto the ramp pad spacer comprises passing the fastener through the ramp, through a ramp attachment hole of the ramp pad spacer, and into the ramp pad.

19. The method of claim 16, further comprising selecting a ramp pad spacer from a plurality of ramp pad spacers, wherein:
the predetermined thickness of each one of the plurality of ramp pad spacers is different from the predetermined thickness of any other one of the plurality of ramp pad spacers; and
the selected one of the plurality of ramp pad spacers is selected based on a desired height offset of the ramp relative to the ramp pad.

20. The method of claim 16, wherein the step of mounting the ramp pad spacer having the predetermined thickness onto the ramp pad of the hard disk drive further comprises aligning a primary docking edge of the ramp pad spacer with a corresponding ramp-pad primary docking surface.
